(19) United States
(12) Patent Application Publication
(10) Pub. No.: US 2019/0333700 A1
(43) Pub. Date: Oct. 31, 2019

(54) COMPLEX DEVICE AND ELECTRONIC DEVICE HAVING SAME

(71) Applicant: MODA-INNOCHIPS CO., LTD., Ansan-Si, Gyeonggi-Do (KR)

(72) Inventors: Seung Hun CHO, Siheung-Si, Gyeonggi-Do (KR); Sung Jin HEO, Ansan-Si, Gyeonggi-Do (KR); Dong Suk LEE, Incheon (KR)

(21) Appl. No.: 16/309,104

(22) PCT Filed: Jul. 25, 2017
(86) PCT No.: PCT/KR2017/007971

§ 371 Date: Dec. 11, 2018

(30) Foreign Application Priority Data
Jul. 27, 2016 (KR) 10-2016-0095594

(51) Int. Cl. H01G 4/40; H01G 4/30; H01C 7/12; H01G 4/012; H01C 13/02

(52) U.S. Cl. CPC H01G 4/40; H01G 4/30; H01G 4/1227; H01G 4/012; H01C 13/02; H01C 7/12

(57) ABSTRACT

Exemplary embodiments provide a complex device including a laminate and two or more functional layers disposed in the laminate and having functions different from each other, wherein each of the two or more functional layers contains at least a portion of a material of another functional layer adjacent thereto, and an electronic device including the same.

### TECHNICAL FIELD

The present disclosure relates to a complex device, and more particularly, to a complex device including two or more functional layers having functions different from each other and an electronic device including the same.

### BACKGROUND

A passive component constituting an electronic circuit includes a resistor, a capacitor, and an inductor and has various functions and roles. For example, the resistor controls a flow of a current flowing in a circuit and serves to perform impedance matching in an alternating current circuit. The capacitor basically blocks a direct current and allows an alternating current to pass through. Also, the capacitor constitutes a time constant circuit, a time delay circuit, and a RC and LC filter circuit. In addition, the capacitor itself serves to remove noise. The inductor implements functions such as high frequency noise removal and impedance matching.

Also, an overvoltage protective component such as a varistor and suppressor is necessary in an electronic circuit to protect an electronic device from an overvoltage such as ESD applied to the electronic device from the outside. That is, the overvoltage protective component is necessary to prevent the overvoltage equal to or greater than a driving voltage from being applied. For example, since the varistor has a resistance varied in accordance with an applied voltage, the varistor is widely used for protecting an electronic component and a circuit from the overvoltage. That is, although a current usually does not flow in the varistor disposed in a circuit, when an overvoltage is applied to both ends of the varistor due to an overvoltage equal to or greater than a breakdown voltage or thunderstroke, the varistor has a remarkably reduced resistance to allow almost all currents to flow through the varistor, and accordingly, the current does not flow to other components, thereby protecting the circuit or the electronic components mounted on the circuit from the overvoltage.

Meanwhile, in recent years, a chip component may be manufactured by laminating at least two or more components having different functions or characteristics to reduce a surface area occupied by the components in response to a miniaturization of electronic devices. For example, the capacitor and the overvoltage protective component are laminated in a single chip to realize a chip component, thereby realizing a high varistor voltage and a high capacitance. That is, since the breakdown voltage is determined by a thickness of the varistor, the varistor may have a relatively low capacitance to realize the high breakdown voltage, and, to compensate this, capacitors made of a material having a high dielectric constant are laminated to improve or maintain the capacitance.

However, since two or more functional layers having functions different from each other have properties different from each other, the two or more functional layers are not firmly adhered to each other. For example, a laminate in which a material of the varistor and a material of the capacitor are laminated is easily delaminated or cracked due to a high temperature sintering. That is, since the material of the varistor and the material of the capacitor have thermal contraction rates different from each other, distortion, delamination, and crack may be generated during a sintering process. Since the delamination and the crack degrades characteristics of the varistor and the capacitor, a practical complex device is difficult to be manufactured.

(Prior Documents)
Korean Registration Patent No. 10-0638802

### Technical Problem

The present disclosure provides a complex device in which two or more functional layers having functions different from each other are laminated.

The present disclosure also provides a complex device capable of preventing delamination, crack, or the like by improving adhesion between two or more functional units having compositions different from each other.

### Technical Solution

In accordance with an exemplary embodiment, a complex device includes: a laminate; and two or more functional layers disposed in the laminate and having functions different from each other. Here, each of the two or more functional layers contains at least a portion of a material of another functional layer adjacent thereto.

Functional layers that are the same as each other may be disposed on an upper portion and a lower portion in the laminate, and a different functional layer may be disposed therebetween.

The complex device may further include a coupling layer disposed between the two or more functional layers.

The coupling layer may have at least one of an constituent and a composition, which are different from those of the two or more functional layers.

The coupling layer may have at least one area having at least one of an constituent and a composition, which are different from those of another area.

The functional layer may include at least two of a resistor, a capacitor, an inductor, a noise filter, a varistor, and a suppressor.

The functional layer may include a capacitor unit and a varistor unit, the capacitor unit may include a plurality of dielectric sheets and two or more internal electrodes, the varistor unit may include a plurality of discharge sheets and two or more discharge electrodes, each of the dielectric sheets may contain a material of the discharge sheets, and each of the discharge sheets may contain a material of the dielectric sheets.

The dielectric sheet may contain 0.2 wt % to 30 wt % of the material of the discharge sheet, and the discharge sheet may contain 0.2 wt % to 30 wt % of the material of the dielectric sheet.

A content of the material of the discharge sheet in the dielectric sheet may gradually increase in a direction that is close to the varistor unit, and a content of the material of the dielectric sheet in the discharge sheet may gradually increase in a direction that is close to the capacitor.

The varistor unit may be greater in thickness than the capacitor unit.

A distance between the discharge sheets may be greater than that between the internal electrodes.

The internal electrode may be greater in thickness than the discharge electrode.

An overlapped surface area between the internal electrodes may be greater than that between the discharge electrodes.

The complex device may further include a coating layer of at least one of polymer and glass, which is formed on a surface of the laminate.

In accordance with another exemplary embodiment, an electronic device including a conductor that a user may touch and an internal circuit with a complex device disposed therebetween includes a complex device including a laminate and two or more functional layers disposed in the laminate and having functions different from each other. Here, at least a portion of each of the two or more functional layers contains at least a portion of a material of another functional layer adjacent thereto.

The electronic device may further include a coupling layer disposed between the two or more functional layers.

The coupling layer may have at least one of an constituent and a composition, which are different from those of the two or more functional layers.

The functional layer may include a capacitor unit and a varistor unit, the capacitor unit may include a plurality of dielectric sheets and two or more internal electrodes, the varistor unit may include a plurality of discharge sheets and two or more discharge electrodes, each of the dielectric sheets may contain a material of the discharge sheets, and each of the discharge sheets may contain a material of the dielectric sheets.

The dielectric sheet may contain 0.2 wt % to 30 wt % of the material of the discharge sheet, and the discharge sheet may contain 0.2 wt % to 30 wt % of the dielectric sheet.

The complex device may allow a transient voltage applied from the outside through the conductor to by-pass through the internal circuit, block an electric shock voltage leaked through the internal circuit, and allow a communication signal to pass through.

### Advantageous Effects

The complex device in accordance with the exemplary embodiments includes two or more functional layers having functions different from each other and laminated therein. The material of one functional layer is partially contained in another functional layer adjacent thereto, and the material of the another functional layer is partially contained in the one functional layer. As the different kinds of materials are contained in each of the different functional layers as described above, the difference between the contraction rates after simultaneous sintering of the laminated complex device may be reduced, and distortion, delamination, and crack may be prevented.

Also, as the coupling layer having the constituent different from that of the two or more functional layers is provided between the two or more functional layers, the coupling force between the functional layers may further improve.

### BRIEF DESCRIPTION OF THE DRAWINGS

Exemplary embodiments can be understood in more detail from the following description taken in conjunction with the accompanying drawings, in which:

FIGS. 1 to 3 are a perspective view, a cross-sectional view, and a detailed cross-sectional view of a complex device in accordance with an exemplary embodiment;

FIG. 4 is a cross-sectional view of a complex device in accordance with another exemplary embodiment;

FIG. 5 is a cross-sectional view of a complex device in accordance with yet another exemplary embodiment;

FIGS. 6 to 10 are cross-sectional view of a complex device in accordance with other exemplary embodiments;

FIGS. 11 and 12 are block diagrams of a complex device in accordance with exemplary embodiments;

FIGS. 13 to 15 are graphs showing contraction rates of a complex device in accordance with exemplary embodiments and a complex device in accordance with comparative examples;

FIG. 16 is a photograph of a complex device after sintering in accordance with a comparative example;

FIG. 17 is a photograph of a complex device after sintering in accordance with an exemplary embodiment; and

FIGS. 18 to 23 are views showing an EDX analysis of a complex device in accordance with an exemplary embodiment.

### DETAILED DESCRIPTION

Hereinafter, specific embodiments will be described in detail with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art.

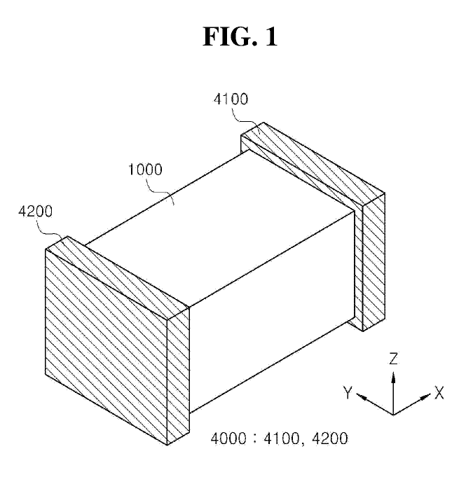

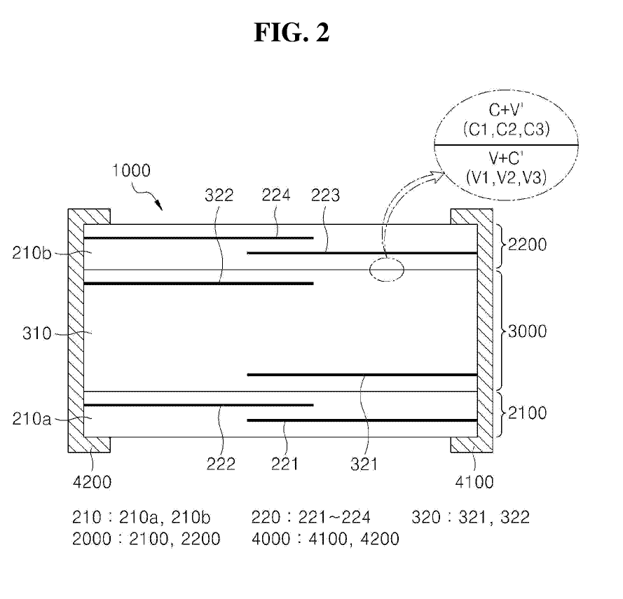

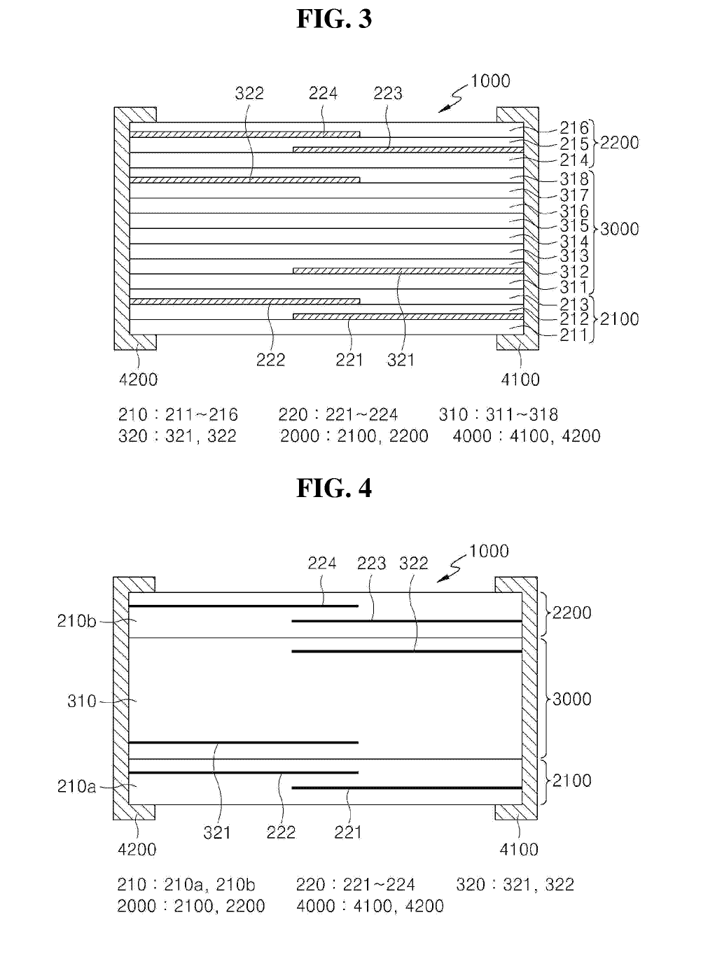

FIG. 1 is a perspective view of a complex device in accordance with an exemplary embodiment, and FIG. 2 is a schematic cross-sectional view. Also, FIG. 3 is a detailed cross-sectional view of a complex device in accordance with an exemplary embodiment.

Referring to FIGS. 1 and 2, the complex device in accordance with an exemplary embodiment may include a laminate 1000 and at least two functional units disposed in the laminate 1000 and having functions different from each other. That is, the complex device may include a first functional unit including at least one of a resistor, a noise filter, an inductor, and a capacitor and a second functional unit including an overvoltage protective part such as a varistor and a suppressor to protect the component from an overvoltage. In other words, the complex device in accordance with an exemplary embodiment may include the first functional unit functioning as a passive component and the second functional unit functioning as the overvoltage protective component. For example, the complex device in accordance with an exemplary embodiment may include the laminate 1000 in which a plurality of sheets and a plurality of conductive layers are laminated, at least one capacitor unit 2000 (2100 and 2200) disposed in the laminate 1000, and at least one overvoltage protective unit 3000. Also, the complex device may further include an external electrodes 4000 (4100 and 4200) respectively provided on both side surfaces facing each other outside the laminate 1000. Here, the laminate 1000 may be vertically divided into three even parts to provide another functional layer between the same functional layers respectively disposed on lower and upper portions thereof. For example, the capacitor unit 2000 may be divided to be disposed below and above the overvoltage protective unit 2000 with the overvoltage protective unit 3000 therebetween. Alternatively, the overvoltage protective unit 3000 may be provided below and above the capacitor unit 2000 with the capacitor unit 2000 therebetween. Also, two or more functional layers having the same function as each other may be formed by simultaneous sintering. As described above, as the same functional layers are disposed on the upper and lower portions of the laminate 1000 and simultaneously sintered, a phenomenon in which the laminate 1000 is bent by a difference between thermal stresses, i.e., a warpage phenomenon may be improved. Here, a plurality of sheets having characteristics of a varistor including the varistor part are laminated in the overvoltage protective unit 3000, and a plurality of sheets having a predetermined dielectric constant are laminated in the capacitor unit 2000. Hereinafter, the plurality of sheets forming the overvoltage protective unit 3000 are called as discharge sheets 310, and the plurality of sheets forming the capacitor unit 2000 are called as dielectric sheets 210 Also, a conductive layer of the overvoltage protective unit 3000 is called as a discharge electrode 320, and a conductive layer of each of the capacitor units 2000 and 4000 is called as an internal electrode 220. Meanwhile, in accordance with an exemplary embodiment, the first functional unit includes at least a portion of a material of the second functional unit, and the second functional unit includes at least a portion of a material of the first functional unit. For example, the capacitor unit 2000 may include a material of the varistor, and the overvoltage protective unit 3000 may include a material of the capacitor. That is, the capacitor unit 2000 includes a material forming the discharge sheet 310, and the varistor unit 3000 includes a material forming the dielectric sheet 210. Here, a material of the other functional unit, which is contained in one functional unit, may be contained less in amount than a material forming the one functional unit. That is, the material of the varistor (i.e., a material of the discharge sheet) is contained less in amount than that of the capacitor (i.e., a material of the dielectric sheet) in the capacitor unit 2000, the material of the capacitor is contained less in amount than that of the varistor in the overvoltage protective unit 3000.

The above-described constitution of the complex device in accordance with an exemplary embodiment will be described below in detail with reference to FIGS. 1 to 3.

### 1. Laminate

The laminate 1000 is formed by laminating a plurality of insulating sheets, i.e., a plurality of dielectric sheets 210 and a plurality of discharge sheets 310. The laminate 1000 may have an approximately hexahedral shape having a predetermined length in each of one direction (e.g., X direction) and the other direction (e.g., Y direction) crossing the one direction and a predetermined height in a vertical direction (e.g., Z direction). Here, when a formation direction of the external electrode 4000 is the X direction, a direction horizontally perpendicular thereto may be the Y direction, and a vertical direction may be the Z direction. Here, a length in the X direction may be greater than that in each of the Y direction and the Z direction, and the length in the Y direction may be equal to or different from that of the Z direction. When the lengths in the Y direction and the Z directions are different from each other, the length in the Y direction may be less or greater than that in the Z direction. For example, a ratio of lengths in the X, Y, and Z directions may be 2 to 5:1:0.5 to 1. That is, with reference to the length in the Y direction, the length in the X direction may be two times to five times greater than that in the Y direction, and the length in the Z direction may be one-half times to one times of that in the Y direction. However, the above-described lengths in the X, Y, and Z directions are examples. For example, the lengths in the X, Y, and Z directions may be variously varied in accordance with an internal structure of an electronic device to which the complex device is connected and the internal structure and shape of the complex device. Also, at least one capacitor unit 2000 and at least one overvoltage protective unit 3000 may be provided in the laminate 1000. For example, the first capacitor unit 2100, the overvoltage protective unit 3000, and the second capacitor unit 2200 may be provided in a lamination direction, i.e., the Z direction. Also, all of the plurality of insulation sheets, i.e., the dielectric sheet 210 and the discharge sheet 310, may have the same thickness as each other, and at least one sheet may have a thickness greater or less than that of each of other sheets. That is, the discharge sheet 310 of the overvoltage protective unit 3000 may have a thickness different from that of the dielectric sheet 210 of the capacitor unit 2000, and the discharge sheet and the dielectric sheet provided between the discharge electrode 320 of the overvoltage protective unit 3000 and the internal electrode 220 of the first and second capacitor units 2100 and 2200 may have thicknesses different from those of other discharge sheets and dielectric sheets. For example, each of the discharge sheets 311 and 318 of the overvoltage protective unit 3000 between the overvoltage protective unit 3000 and the first and second capacitor units 2100 and 2200 may have the thickness equal to or greater than that of each of the discharge sheets 312 to 317 of the overvoltage protective unit 3000 or equal to or greater than that of the dielectric sheet 210 of the first and second capacitor units 2100 and 2200. That is, a distance between the overvoltage protective unit 3000 and the first and second capacitor units 2100 and 2200 may be equal to or greater than that between the internal electrodes of the first and second capacitor units 2100 and 2200 and equal to or less than that of the overvoltage protective unit 3000. Alternatively, the dielectric sheets 210 of the first and second capacitors 2100 and 2200 may have the same thickness, or one thereof may have the thickness less or greater than that of the other thereof. For example, each of the dielectric sheets 212 and 215 between the internal electrodes 220 may be less or greater in thickness than each of the dielectric sheets 211, 213, 214, and 216 disposed outside the internal electrodes 220. Meanwhile, the insulation sheets, i.e., the dielectric sheets 210 and the discharge sheets 310, may have the thickness that is not damaged when an overvoltage such as ESD is applied, e.g., 5 μm to 300 μm. Also, the laminate 1000 may further include a lower cover layer (not shown) and an upper cover layer (not shown) respectively disposed on lower and upper portions of the first and second capacitor units 2100 and 2200. Alternatively, a lowermost insulation sheet may function as the lower cover layer, and an uppermost insulation sheet may function as the upper cover layer. That is, the lowermost dielectric sheet of the first capacitor unit 2100 may function as the lower cover layer, and the uppermost dielectric sheet of the second capacitor unit 2200 may function as the upper cover layer. The lower and upper cover layers that are separately provided may have the same thickness as each other or provided by laminating a plurality of magnetic material sheets. However, the lower and upper cover layers may have the thicknesses different from each other. For example, the upper cover layer may be greater in thickness than the lower cover layer. Here, a non-magnetic sheet, e.g., a glass sheet, may be further formed on outermost portions of the lower and upper cover layers made of the magnetic material sheet, i.e., lower and upper surfaces thereof. Also, each of the lower and upper cover layers may have the thickness greater than that of each of the internal insulation sheets. Accordingly, when the lowermost and uppermost insulation sheets respectively function as the lower and upper cover layers, each of the lowermost and uppermost insulation sheets may be greater in thickness than the insulation sheets therebetween. Meanwhile, the lower and upper cover layers may be formed of a glass sheet. Also, a surface of the laminate 1000 may be coated with a polymer or a glass material.

### 2. Capacitor Unit

The capacitor units 2000 is respectively provided below and above the overvoltage protective unit 3000. That is, the first capacitor unit 2100 may be provided below the overvoltage protective unit 3000, and the second capacitor unit 2200 may be provided above the overvoltage protective unit 3000. Also, each of the first and second capacitor units 2100 and 2200 may include at least two or more internal electrodes and two or more dielectric sheets disposed between the internal electrodes. For example, as illustrated in FIG. 3, the first capacitor unit 2100 may include first to third dielectric sheets 210a (211 to 213) and first and second internal electrodes 221 and 222, and the second capacitor unit 2200 may include fourth to sixth dielectric sheets 210b (214 to 216) and third and fourth internal electrodes 223 and 224. Meanwhile, although each of the first and second capacitor units 2100 and 2200 includes two internal electrodes and three dielectric sheets for the two internal electrodes in the embodiment, three or more dielectric sheets may be provided, and two or more internal electrodes may be provided.

The dielectric sheets 210 (211 to 216) may be formed by mixing a dielectric material with an overvoltage protective material such as a varistor material. That is, as illustrated in an enlarged portion in FIG. 2, the dielectric sheets 210 is mainly formed of a dielectric material C and partially formed of a varistor material V′. A high dielectric material having a dielectric constant of, e.g., 200 to 3000 may be used for the dielectric material. For example, MLCC, LTCC, and HTCC may be used for the dielectric material. That is, the dielectric sheets 210 may be formed of a material containing at least on of BaTiO₃, NdTiO₃, Bi₂O₃, BaCO₃, TiO₂, Nd₂O₃, SiO₂, CuO, MgO, ZnO, and Al₂O₃. Here, the MLCC dielectric material may have a main constituent including at least one of BaTiO₃ and NdTiO₃, and at least one of Bi₂O₃, SiO₂, CuO, and MgO may be added thereto. The LTCC dielectric material may include Al₂O₃, SiO₂, and a glass material. Also, the overvoltage protective material may include a material forming the overvoltage protective unit 3000 that will be described later, e.g., a material forming the discharge sheet of the overvoltage protective unit 3000. The overvoltage protective material may used a varistor material. The varistor material may include at least one of ZnO, Bi₂O₃, Pr₆O₁₁, Co₃O₄, Mn₃O₄, CaCO₃, Cr₂O₃, SiO₂, Al₂O₃, Sb₂O₃, SiC, Y₂O₃, NiO, SnO₂, CuO, TiO₂, MgO, and AgO. For example, the varistor material contained in the capacitor unit 2000 may be ZnO. Here, a particle size of the ZnO may be less than 1 μm with reference to an average size distribution (D50). Also, a capacitor material may have a composition for sintering under air atmosphere instead of deoxidation atmosphere. That is, since the varistor material having a main material of ZnO may not properly realize the characteristics of the varisor under the deoxidation atmosphere, the capacitor material need to be sintered under the air atmosphere. Accordingly, the complex device is sintered in the same manner under the air atmosphere for sintering the varistor. Meanwhile, an amount of the varistor material contained in the capacitor unit 2000 may be 0.2 wt % to 30 wt %. That is, the varistor material may be contained at about 0.2 wt % to about 30 wt % on the basis of 100 wt % of a mixed material of the dielectric material and the varistor material to form the dielectric sheets 210 of the capacitor unit 2000. The varistor material may be desirably contained at 5 wt % to 25 wt % on the basis of 100 wt % of a mixture of the capacitor material and the varistor material, and more desirably contained at 10 wt % to 20 wt %. Here, when the overvoltage protective material, i.e., the varistor material is contained less than 0.2 wt %, an adhesion strength may be insignificantly improved. When the varistor material is contained greater than 30 wt %, the capacitance of the capacitor unit 2000 may be degraded, or at least a portion of a discharge voltage may flow through the capacitor unit 2000. As described above, as the capacitor unit 2000 contains a portion of the varistor material, a coupling force with the overvoltage protective unit 3000 may be improved, and accordingly, delamination and crack may be prevented. Meanwhile, a content of a material, e.g., the varistor material, which is partially contained in the capacitor unit 2000, may gradually increase in a direction that is close to the overvoltage protective unit 300. For example, a content of the varistor material contained in the third dielectric sheet 213 may be greater than that contained in the first and second dielectric sheets 211 and 212, and a content of the varistor material contained in the fourth dielectric sheet 214 may be greater than that contained in the fifth and sixth dielectric sheets 215 and 216. Here, the varistor material may not be contained in the first and second dielectric sheets 211 and 212 and fifth and sixth dielectric sheets 215 and 216. That is, since the varistor material is contained in the capacitor unit 2000 to increase the coupling force with the varistor unit 3000, the varistor material may exist only in an area adjacent to the varistor unit 3000 or gradually increase in content in a direction that is close to the varistor unit 3000. Accordingly, as the varistor material is contained only in the area adjacent to the varistor unit 3000 or the content of the varistor material gradually increases in the direction that is close to the varistor unit 3000, the capacitance of the capacitor unit 2000 may be maintained as it is and the adhesion force of the varistor unit 3000 may be improved.

The internal electrodes 220 (221, 222, 223, and 224) may be made of a conductive material including, e.g., metal containing at least one of Ag, Au, Pt, and Pd or a metallic alloy thereof. In case of an alloy, for example, an alloy of Ag and Pd may be used. Also, the internal electrodes 220 may have a thickness of, e.g., 1 μm to 10 μm. Here, each of the internal electrodes 220 has one side connected to the external electrodes 4000 (4100 and 4200) facing each other in the X-direction and the other side spaced therefrom. That is, the first and third internal electrodes 221 and 223 are respectively provided on the first and fourth dielectric sheets 211 and 214 to have a predetermined surface area. Each of the first and third internal electrodes 221 and 223 has one side connected to the first external electrode 4100 and the other side spaced apart from the second external electrode 4200. Also, the second and fourth internal electrodes 222 and 224 are respectively provided on the second and fifth dielectric sheets 212 and 214 to have a predetermined surface area. Each of the second and fourth internal electrodes 222 and 224 has one side connected to the second external electrode 4200 and the other side spaced apart from the first external electrode 4100. That is, the first and second internal electrodes 221 and 222 are alternately connected to one of the external electrodes 40000 and overlap a predetermined area with the second dielectric sheet 212 therebetween. Also, the third and fourth internal electrodes 223 and 224 are alternately connected to one of the external electrodes 40000 and overlap a predetermined area with the fifth dielectric sheet 215 therebetween. Here, each of the internal electrodes 220 has a surface area that is 10% to 85% of that of each of the dielectric sheets 210. Also, two adjacent internal electrodes 220, i.e., the first and second internal electrodes 221 and 222 and the third and fourth internal electrodes 223 and 224, overlap a surface area that is 10% to 85% of that of each thereof. Meanwhile, the internal electrodes 220 may have various shapes such as a square, a rectangle, and a spiral having a predetermined pattern shape and a predetermined with and distance. As described above, the capacitor unit 2000 may have the capacitance between the first and second internal electrodes 221 and 222 and between the third and fourth internal electrodes 223 and 224, and the capacitance may be adjusted according to the overlapped surface area of the adjacent internal electrodes 220 and the thickness of each of the dielectric sheets 211 to 216.

### 3. Overvoltage Protective Unit

The overvoltage protective unit 3000 may be disposed between the capacitor units 2000. That is, the first capacitor unit 2100 may be provided on the lower portion of the overvoltage protective unit 3000, and the second capacitor unit 2200 may be provided on the upper portion of the overvoltage protective unit 3000. The overvoltage protective unit 3000 may include a plurality of discharge sheets and two or more discharge electrodes 320 (321 and 322). For example, as illustrated in FIG. 3, the overvoltage protective unit 3000 may include first to eighth discharge sheets 310 (311 to 318) and first and second discharge electrode 320 (321 and 322) disposed with second to seventh discharge sheets 312 to 317 therebetween. Meanwhile, although the overvoltage protective unit 3000 includes eight discharge sheets 310 and two discharge electrodes 320 in the embodiment, the number of the discharge sheets 310 and the number of the discharge electrodes 320 may be varied. Also, although each of the discharge sheets 310 is illustrated to have a thickness equal to that of each of the dielectric sheets 210, the discharge sheets 310 and the dielectric sheets 210 may have thicknesses different from each other. For example, the thickness of each of the discharge sheets 310 may be greater than that of each of the dielectric sheets 210. Meanwhile, a breakdown voltage or a discharge inception voltage, at which the discharge of the overvoltage protective unit 3000 initiates, may be determined according to a material of the discharge sheets 310 and a distance between the discharge electrodes 320.

The discharge sheets 310 (311 to 318) may be made of a mixed material of the varistor material and the dielectric material. That is, the discharge sheets 310 may be formed by mixing a material having the characteristics of the varistor and a material forming the capacitor unit 2000, i.e., a dielectric material. As illustrated in an enlarged portion in FIG. 2, the discharge sheets 310 mainly includes the varistor material V and partially includes the capacitor material C′. The varistor material may include at least one of ZnO, Bi₂O₃, Pr₆O₁₁, Co₃O₄, Mn₃O₄, CaCO₃, Cr₂O₃, SiO₂, Al₂O₃, Sb₂O₃, SiC, Y₂O₃, NiO, SnO₂, CuO, TiO₂, MgO, and AgO. For example, a material in which a main constituent of ZnO is mixed with at least one of the above-listed materials may be used as the varistor material. Alternatively, the varistor material may use Pr, Bi, and SiC-based materials in addition to the above-listed materials. Also, the dielectric material mixed in the varistor material may include a main material of the dielectric sheets 210 of the capacitor units 2000. That is, the dielectric material such as MLCC, LTCC, and HTCC having a dielectric constant of about 200 to about 3000 may be mixed in the varistor material. For example, a material containing at least one of BaTiO₃, NdTiO₃, Bi₂O₃, BaCO₃, TiO₂, Nd₂O₃, SiO₂, CuO, MgO, ZnO, and Al₂O₃ may be mixed in the varistor material. For example, the capacitor material contained in the overvoltage protective unit 3000, i.e., the dielectric material may be at least one of BaTiO₃ and NdTiO₃. Meanwhile, an amount of the capacitor material contained in the overvoltage protective unit 3000, i.e., an amount of the dielectric material, may be 0.2 wt % to 30 wt %. That is, the dielectric sheet material may be contained at 0.2 wt % to 30 wt % on the basis of 100 wt % of a mixed material of the discharge sheet material and the dielectric material. The dielectric material may be desirably contained at 5 wt % to 25 wt % on the basis of 100 wt % of the mixture of the discharge sheet material and the dielectric material, and more desirably contained at 10 wt % to 20 wt %. Here, when the capacitor material, i.e., the dielectric sheet material, is contained less than 0.2 wt %, the adhesion strength slightly increases. When the dielectric sheet material is contained greater than 30 wt %, characteristics of the overvoltage protective unit 3000 may be degraded. That is, as the overvoltage protective unit may be varied in breakdown voltage or fully changed into a non-conductor not to discharge an overvoltage, the overvoltage protective unit may lose its own function. As described above, as the overvoltage protective unit 3000 partially contains the capacitor material, i.e., the dielectric sheet material, the coupling force with the capacitor unit 2000 may be improved, and accordingly, a limitation such as delamination and crack may be prevented. Meanwhile, each of the discharge sheets 310 may have a thickness equal to or different from that of each of the dielectric sheets 210. For example, the thickness of each of the discharge sheets 310 may be equal to or less than that of each of the dielectric sheets 210, and the number of lamination of the discharge sheets 310 may be greater than that of the dielectric sheets 210. Also, the thickness of each of the discharge sheets 310 may be greater than that of each of the dielectric sheets 210, and the number of lamination of the discharge sheets 310 may be equal to that of the dielectric sheets 210. Meanwhile, the capacitor material partially contained in the overvoltage protective unit 3000 may increase in content in a direction that is close to the capacitor unit 2000. For example, a content of the capacitor material may gradually increase downward and upward from the fourth and fifth discharge sheets 314 and 315. Also, a content of the capacitor material of the first and eighth discharge sheets 311 and 318 may be greater than that of the rest of the discharge sheets 312 to 317. Here, the capacitor material may not be contained in the second to seventh discharge sheets 312 to 317. That is, since the capacitor material is contained in the overvoltage protective unit 3000 so as to improve the coupling force with the capacitor unit 2000, the capacitor material exists only in an area adjacent to the capacitor unit 2000 or gradually increases in content in a direction that is close to the capacitor unit 2000. Accordingly, as the capacitor material is contained only in the area adjacent to the capacitor unit 2000 or the content of the capacitor material gradually increases in the direction that is close to the capacitor unit 2000, the characteristics of the varistor unit 3000 may be maintained as they are, and the adhesion force with the capacitor unit 2000 may be improved.

The first and second discharge electrodes 320 (321 and 322) may be made of a conductive material, e.g., metal or a metallic alloy containing at least one of Ag, Au, Pt, and Pd. For example, the alloy may include an alloy of Ag and Pd. Here, the discharge electrodes 320 may be made of the same material as that of the internal electrodes 220 of the capacitor unit 2000. Also, each of the discharge electrodes 320 may have a thickness of, e.g., 1 μm to 10 μm. That is, the discharge electrode 320 may have the same thickness as that of each of the internal electrodes 220. However, the discharge electrode 320 may have the thickness less than or greater than that of each of the internal electrodes 220. For example, the discharge electrode 320 may have the thickness less than by about 1.1 times to about 5 times than that of each of the internal electrodes 220. For example, the discharge electrode 320 may have the thickness of 1 μm to 5 μm, and each of the internal electrodes 220 may have the thickness of 5 μm to 10 μm. Meanwhile, the discharge electrode 320 and the external electrode 4000 may be alternately connected to each other. That is, the first discharge electrode 321 is connected to the first external electrode 4100 and disposed on the first discharge sheet 311, and the second discharge electrode 322 is connected to the second external electrode 4200 and disposed on the seventh discharge sheet 317. That is, the first and second discharge electrodes 321 and 322 are alternately connected to one of the external electrodes 4000 and overlap a predetermined area thereof with the second and seventh discharge sheets 311 to 317 therebetween. Here, each of the first and second discharge electrodes 321 and 322 has a surface area of 10% to 85% with respect to that of each of the discharge sheets 310. Also, the first and second discharge electrodes 321 and 322 overlap surface areas of 10% to 85% with respect to that of each thereof.

Meanwhile, the overvoltage protective unit 3000 may have a thickness greater than that of the capacitor unit 2000. That is, the overvoltage protective unit 3000 may have the thickness greater than that of each of the capacitor units 2000 and equal to or greater than the sum of the thicknesses of the capacitor units 2000. Also, the overvoltage protective unit 3000 has a predetermined capacitance less than that of the capacitor unit 2000. That is, since the capacitance of the capacitor unit 2000 is greater than that of the overvoltage protective unit 3000, the total capacitance of the complex device may increase. Here, the capacitance of the capacitor unit 2000 may be greater by one times to 500 times than that of the overvoltage protective unit 3000.

Also, the breakdown voltage of the overvoltage protective unit 3000 may be equal to or greater than 310 V and less than the insulation breakdown voltage of the capacitor unit 2000. That is, the breakdown voltage of the overvoltage protective unit 3000 may be equal to or greater than 310 V and less than the insulation breakdown voltage of the capacitor unit 2000. As the breakdown voltage is less than the insulation breakdown voltage, the capacitor unit 2000 may discharge the overvoltage before voltage breakdown. Also, the distance between the internal electrodes 220 of the capacitor unit 2000 may be less than that between the discharge electrodes 320 of the overvoltage protective unit 3000. Also, the overlapped surface area of the discharge electrodes 320 of the overvoltage protective unit 3000 may be less than that of the internal electrodes 220 of the capacitor unit 2000.

### 4. External Electrode

The external electrodes 4000 (4100 and 4200) are provided on both side surfaces, which face each other, of the laminate 1000 and selectively connected to the internal electrodes 220 and the discharge electrodes 320, which are disposed in the laminate 1000. That is, each of the external electrodes 4000 may be provided on each of two side surfaces facing each other, e.g., first and second side surfaces, or two or more external electrodes 4000 may be provided on each thereof. The external electrode 4000 may be formed in at least one layer. The external electrode 4000 may be made of a metal layer such as Ag, and at least one plating layer may be provided on the metal layer. For example, the external electrode 4000 may be formed by laminating a copper layer, a Ni plating layer, and Sn or Sn/Ag plating layer. Also, the external electrode 4000 may be formed by mixing, e.g., multi-constituent glass frit having a main constituent of Bi₂O₃ or SiO₂ of 0.5% to 20% with metal powder. Here, the mixture of the glass frit and the metal powder may be prepared in a paste type and applied to two surfaces of the laminate 1000. As the glass frit is contained in the external electrode 4000, the adhesion force between the external electrode 4000 and the laminate 1000 may be improved, and a contact reaction between a conductive pattern in the laminate 1000 and the external electrode 4000 may be improved. Also, a conductive paste including glass may be applied, and then at least one plating layer may be formed thereon to form the external electrode 4000. That is, the external electrode 4000 may be formed of the metal layer including glass and at least one plating layer thereon. For example, the external electrode 4000 may be formed in such a manner that a layer containing at least one of glass frit, Ag, and Cu is formed, and then a Ni plating layer and a Sn plating layer are sequentially formed through an electroless plating. Here, the Sn plating layer may have a thickness equal to or greater than that of the Ni plating layer. Alternately, the external electrodes 4000 may be formed by at least one plating layer. That is, the external electrode 4000 may be formed by forming at least one layer of a plating layer through at least single plating process without applying the paste. Meanwhile, the external electrode 4000 may have a thickness of 2 μm to 100 μm, the Ni plating layer may have a thickness of 1 μm to 10 μm, and the Sn or Sn/Ag plating layer may have a thickness of 2 μm to 10 μm.

Meanwhile, in a complex device in accordance with another exemplary embodiment, as illustrated in FIG. 4, two internal electrodes adjacent to the discharge electrodes 321 and 322, i.e., the second and third internal electrodes 222 and 223 may be connected to the same external electrode 4000 as that of the discharge electrodes 321 and 322. That is, the first and third internal electrodes 221 and 223 are connected to the second external electrode 4200, and the second and fourth internal electrodes 222 and 224 are connected to the first external electrode 4100. Also, the first discharge electrode 321 is connected to the first external electrode 4100, and the second discharge electrode 322 is connected to the second external electrode 4200. Accordingly, the first discharge electrode 321 and the second internal electrode 222 adjacent thereto are connected to the first external electrode 4100, and second discharge electrode 322 and the third internal electrode 223 adjacent thereto are connected to the second external electrode 4200

As described above, as the discharge electrode 320 and the internal electrode 220 adjacent thereto are connected to the same external electrode 4000, an overvoltage such as ESD is not applied into an electronic device even when the dielectric sheets 210 is depleted, i.e., when the insulation is broken down. That is, when the internal electrodes 220 adjacent to the discharge electrode 320 are connected the external electrodes 4000 different from each other, an overvoltage applied through one external electrode 4000 flows to the other external electrode 4000 through the internal electrodes 220 adjacent to the discharge electrode 320. For example, as illustrated in FIG. 2, when the first discharge electrode 321 is connected to the first external electrode 4100, and the second internal electrode 222 adjacent thereto is connected to the second external electrode 4200, if insulation of the dielectric sheet 113 is broken down, a conductive path may be formed between the first discharge electrode 321 and the second internal electrode 222 to allow the overvoltage applied through the first external electrode 4100 to flow to the first discharge electrode 321, the insulation broken third insulation sheet 213, and the second internal electrode 222. Accordingly, the overvoltage may be applied to an internal circuit of the electronic device through the second external electrode 4200. To solve the above-described limitation, although the dielectric sheet 210 has a thick thickness, in this case, the complex device may increase in size. However, as illustrated in FIG. 4, as the discharge electrode 320 and the internal electrode 220 adjacent thereto are connected to the same external electrode 4000, even when insulation of the dielectric sheet 210 is broken down, the overvoltage may not be applied into the electronic device. Also, although the dielectric sheet 210 is not thick in thickness, the overvoltage may be prevented to be applied.

However, when the discharge electrodes 321 and 322 and the internal electrodes 222 and 223 respectively adjacent thereto are connected to the same external electrode 4000, i.e., connected in the same direction, the capacitance of the complex device may be degraded. On the contrary, when the discharge electrodes 321 and 322 and the internal electrodes 222 and 223 respectively adjacent thereto are connected to the external electrodes 4000 different from each other, i.e., connected in a reverse direction, the capacitance of the complex device may not be degraded. That is, when the discharge electrodes 321 and 322 and the internal electrodes 222 and 223 respectively adjacent thereto are connected in the reverse direction, the capacitance of the complex device may not be degraded, but the overvoltage may be introduced into the electronic device as insulation of the dielectric sheet 210 is broken down. Also, when connected in the same direction, although insulation of the dielectric sheet 210 is broken down, the overvoltage may not be introduced, but the capacitance of the complex device may be degraded.

However, the disadvantage of the same directional or reverse directional connection between the discharge electrodes 321 and 322 and the internal electrodes 222 and 223 respectively adjacent thereto may be resolved by adjusting a mixing ratio of constituents. That is, in case of the same directional connection, the content of the varistor material added to the capacitor unit 2000 may relatively increase, and the content of the capacitor material added to the overvoltage protective unit 3000 may relatively decrease. Also, in case of the reverse directional connection, the content of the varistor material added to the capacitor unit 2000 may relatively decrease, and the content of the capacitor material added to the overvoltage protective unit 3000 may relatively increase.

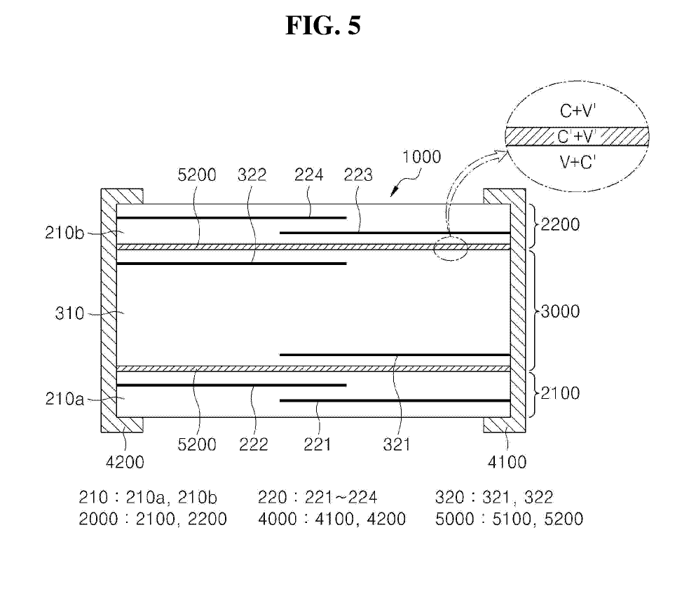

FIG. 5 is a schematic cross-sectional view of a complex device in accordance with yet another exemplary embodiment.

Referring to FIG. 5, the complex device in accordance with yet another exemplary embodiment may include: a laminate 1000 in which a plurality of insulation sheets including a dielectric sheet and a discharge sheet are laminated; a capacitor unit 2000 and an overvoltage protective unit 3000 disposed in the laminate 1000 to have different functions as first and second functional layers; an external electrode 4000 disposed outside the laminate 1000; and a coupling layer 5000 disposed between the capacitor unit 2000 and the overvoltage protective unit 3000. As illustrated in an enlarged portion in FIG. 5, the coupling layer 5000 may be formed of a capacitor material C′ and an overvoltage protective material, e.g., a varistor material V′.

That is, the coupling layer 5000 may include a first coupling layer 5100 disposed between a first capacitor unit 2100 and the overvoltage protective unit 3000 and a second coupling layer 5200 disposed between a second capacitor unit 2200 and the overvoltage protective unit 3000. Here, the coupling layer 5000 may have a dielectric constant less than that of the capacitor unit 2000 and greater than that of the overvoltage protective unit 3000. Also, the coupling layer 5000 may have a dielectric resistance less than that of the capacitor unit 2000 and greater than that of the overvoltage protective unit 3000. For example, the capacitor unit 2000 may have a dielectric resistance equal to or greater than 1000 MΩ·mm, the overvoltage protective unit 3000 may have a dielectric resistance equal to or greater than 100 MΩ·mm, and the coupling layer 5000 may have a dielectric resistance equal to or greater than 300 MΩ·mm The coupling layer 5000 may be formed by diffusing, e.g., a formation material of the capacitor unit 2000 and a formation material of the overvoltage protective unit 3000 when simultaneously sintered at a temperature of 900° C. to 1150° C. That is, the dielectric sheet material of the capacitor unit 2000 and the discharge sheet material of the overvoltage protective unit 3000 may be mutually diffused to form the coupling layer 5000 on an interface between the capacitor unit 2000 and the overvoltage protective unit 3000. Alternatively, the coupling layer 5000 may be formed by inserting at least one sheet having a composition and/or an constituent different from that of the capacitor unit 2000 and the overvoltage protective unit 3000 between the capacitor unit 2000 and the overvoltage protective unit 3000. For example, the first coupling layer 5100 may be formed by substituting a partial thickness of the third dielectric sheet 213 and the first discharge sheet 311 between the third dielectric sheet 213 and the first discharge sheet 311, and the second coupling layer 5100 may be formed by substituting a partial thickness of the fourth dielectric sheet 214 and the eighth discharge sheet 318 between the fourth dielectric sheet 214 and the eighth discharge sheet 318. Accordingly, the coupling layer 5000 may be formed of an constituent having a composition different from that of the capacitor unit 2000 and the overvoltage protective unit 3000. That is, the coupling layer 5000 may be formed of a mixed material of the capacitor material and the varistor material. Here, the coupling layer 5000 may be formed of, e.g., 10 wt % to 90 wt % of the capacitor material and 10 wt % to 90 wt % of the varistor material. That is, the coupling layer 5000 may be formed of 10 wt % to 90 wt % of the capacitor material and 10 wt % to 90 wt % of the varistor material on the basis of 100 wt % of the mixed material. Also, the coupling layer 5000 may have different compositions for each area. The composition of the capacitor unit 2000 may gradually increase in a direction that is close to the capacitor unit 2000, and the composition of the overvoltage protective unit 3000 may gradually increase in a direction that is close to the overvoltage protective unit 3000. That is, the coupling layer 5000 may be formed to have the composition of the overvoltage protective material gradually increasing from the capacitor unit 2000 to the overvoltage protective unit 3000. Meanwhile, the thickness of each of the first and second coupling layers 5100 and 5200 may be less or greater than that of each of the dielectric sheet 210 and the discharge sheet 310. That is, since the coupling layer 5000 is formed by substituting a portion of each of the dielectric sheet 210 and the discharge sheet 310, which are adjacent to each other, the thickness may be varied in accordance with a temperature and time of sintering, and accordingly, less or greater than that of the dielectric sheet 210 or the discharge sheet 310. As the coupling layer 5000 is formed as described above, a coupling force between the capacitor unit 2000 and overvoltage protective unit 3000 may be improved. That is, the materials forming the capacitor unit 2000 and overvoltage protective unit 3000 may be mutually diffused to form a different kind of coupling layer 5000 on an interface therebetween, thereby improving the coupling force therebetween. In other words, as the material forming the overvoltage protective unit 3000 may be partially contained in the capacitor unit 2000, and the material forming the capacitor unit 2000 may be partially contained in the overvoltage protective unit 3000, a difference between contraction rates thereof may be enhanced to improve the coupling force. In addition, as another material different from that of each of the capacitor unit 2000 and overvoltage protective unit 3000, i.e., the coupling layer 5000 having a material content different from that of each thereof is formed, the coupling force between capacitor unit 2000 and overvoltage protective unit 3000 may be further improved. Also, as the coupling layer 5000 is formed, the material of the overvoltage protective unit 3000 may be prevented to be diffused into the capacitor unit 2000, and the material of the capacitor unit 2000 may be prevented to be diffused into the capacitor unit 2000, a functional degradation due to the diffusion of the different kind of material may be prevented. That is, when the overvoltage protective material is diffused into the capacitor unit 2000, the capacitance of the capacitor unit 2000 may be varied, and when the capacitor material is diffused into the overvoltage protective unit 3000, the breakdown voltage of the overvoltage protective unit may be varied or changed into a nonconductor. Thus, as the coupling layer 5000 is formed to prevent the mutual diffusion, the functional degradation may be prevented.

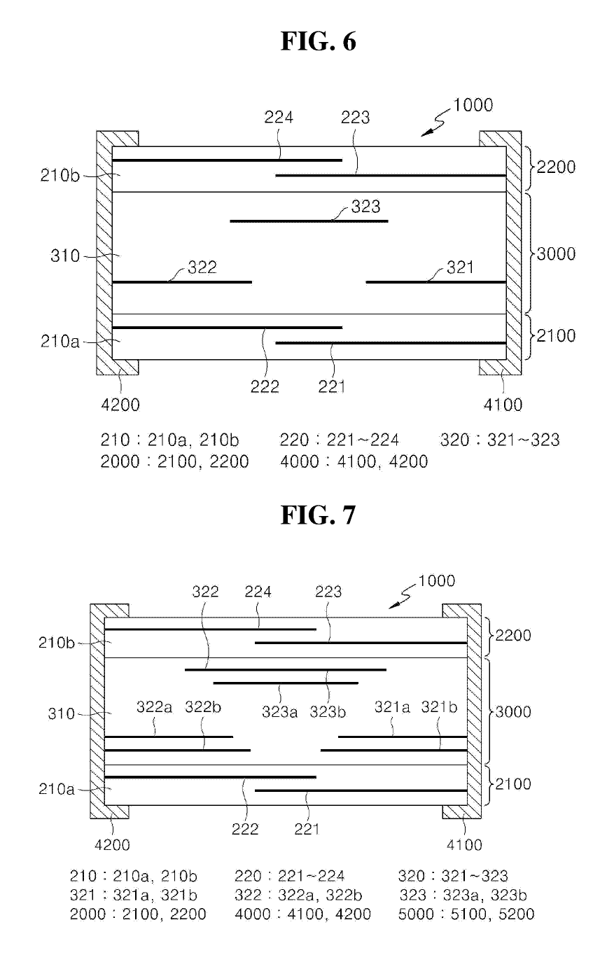

Meanwhile, the complex device in accordance with an exemplary embodiment may have the discharge electrode 320 of the overvoltage protective unit 3000 having various shapes. For example, as illustrated in FIG. 6, the first and second discharge electrodes 321 and 322 disposed on the same plane and connected to the external electrodes 4000 different from each other are spaced a predetermined distance from each other, and the third discharge electrode 323 may be disposed thereabove or therebelow to partially overlap the first and second discharge electrodes 321 and 322. More detailed description for this will be as follows. As illustrated in FIG. 6, the first discharge electrode 321 is connected to the first external electrode 4100 and disposed on one discharge sheet 310, e.g., the second discharge sheet 312 in FIG. 3, and the second discharge electrode 322 is connected to the second external electrode 4200 and disposed on one discharge sheet 310 on which the first discharge electrode 321 is disposed, e.g., the second discharge sheet 312. Here, the first and second discharge electrodes 321 and 322 are spaced a predetermined distance from each other. Also, the third discharge electrode 323 is disposed on one discharge sheet 310 disposed above the first and second discharge electrodes 321 and 322, e.g., the fifth discharge sheet 315, and have one side and the other side overlapping a predetermined area of the first and second discharge electrodes 321 and 322. In the overvoltage protective unit 3000 having the above-described structure, the overvoltage applied from the outside may be transmitted to the third discharge electrode 323 through the first discharge electrode 321 and transmitted again to the second discharge electrode 322, thereby being by-passed to a ground terminal of the internal circuit.

Also, the overvoltage protective unit 3000 may include two of each of first to third discharge electrodes 321, 322, and 323. As illustrated in FIG. 7, each of two first discharge electrodes 321a and 321b is connected to the first external electrode 4100 and disposed on, e.g., the second and third discharge sheets 312 and 323 in FIG. 3. The two discharge electrodes 322a and 322b is connected to the second external electrode 4200 and respectively disposed on the second and third discharge sheets 312 and 313, on which the first discharge electrodes 321a and 321b are respectively disposed. Here, each the first discharge electrodes 321a and 321b and each of the second discharge electrodes 322a and 322b are spaced a predetermined distance from each other. Also, the third discharge electrode 323a is disposed on one discharge sheet 310 disposed above the first discharge electrodes 321a and 322a, e.g., the fifth discharge sheet 315, and have one side and the other side overlapping a predetermined area of the first discharge electrodes 321a and 322a. Also, the third discharge electrode 323b is disposed on one discharge sheet disposed above the third discharge sheet 323a, e.g., the sixth discharge electrode 316. Here, each of the first and second discharge electrode 321b and 322b is greater in length than the first and second discharge electrodes 321a and 322a, and the third discharge electrode 323b is greater in length than the third discharge electrode 323a. Also, the first, second, and third discharge electrodes 321b, 322b, and 323b are greater in width than the first, second, and third discharge electrodes 321a, 322a, and 323a, respectively. As described above, as each of the discharge electrodes 320 is provided in two or more, various discharge paths may be provided, and accordingly, the discharge efficiency may be further improved.

As illustrated in FIGS. 6 and 7, even when the discharge electrodes 320 of the overvoltage protective unit 3000 have the same shape as each other, the first and second coupling layers 5100 and 5200 in FIG. 5 may be provided between the capacitor unit 2000 and the overvoltage protective unit 3000.

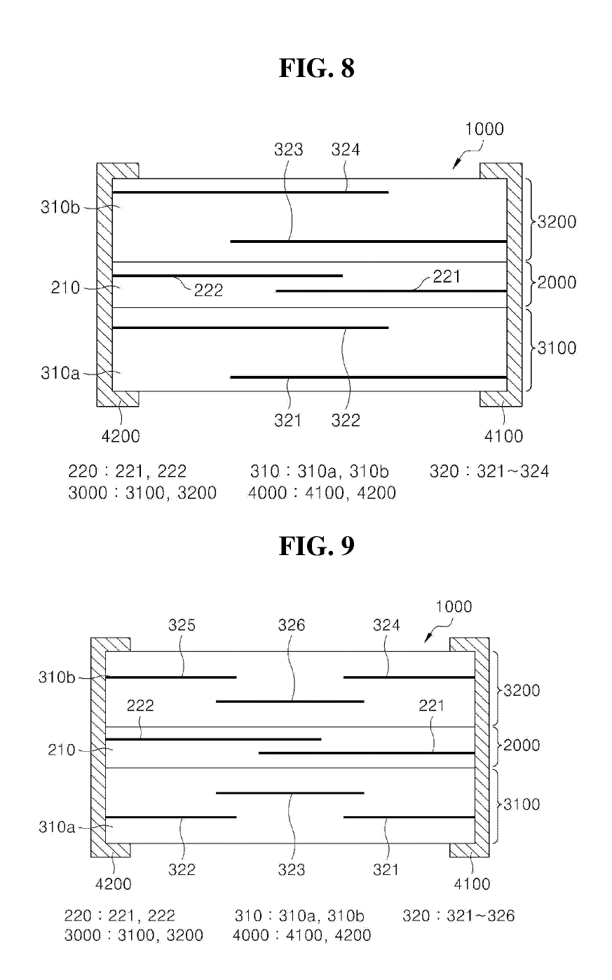

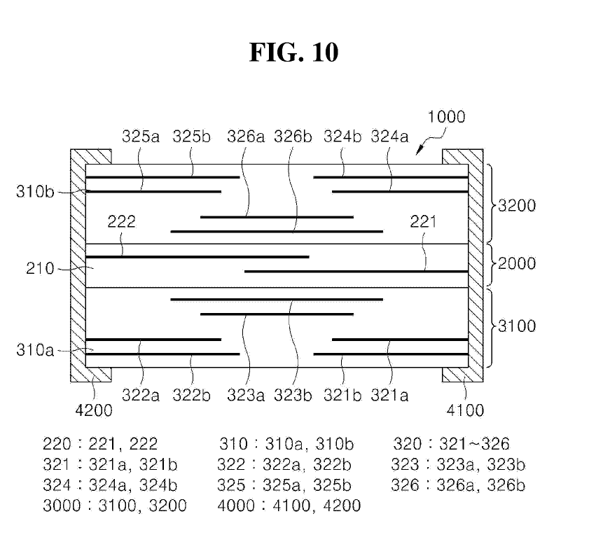

Meanwhile, the complex device in accordance with an exemplary embodiment may have one capacitor unit 2000 and two or more overvoltage protective units. As illustrated in FIGS. 8 to 10, the complex device in accordance with an exemplary embodiment may include first and second overvoltage protective units 3100 and 3200 disposed below and above the capacitor unit 2000. Here, each of the first and second overvoltage protective units 3100 and 3200 may have a thickness greater than that of the capacitor unit 2000. For example, a total thickness of the first and second overvoltage protective units 3100 and 3200 may be greater than that of the capacitor unit 2000, or a thickness of each of the first and second overvoltage protective units 3100 and 3200 may be equal to or greater than that of the capacitor unit 2000. Also, the first and second overvoltage protective units 3100 and 3200 may have the same thickness as each other or different thicknesses from each other. Furthermore, when the first and second overvoltage protective units 3100 and 3200 have the different thicknesses from each other, distances between the discharge electrodes 321 to 324 of the overvoltage protective units 3100 and 3200 may be equal to each other. That is, when the discharge sheets 301 of the first and second overvoltage protective units 3100 and 3200 have the same materials as each other, if the distance between the first and second discharge electrodes and the distance between the third and fourth discharge electrodes are equal to each other, the breakdown voltages of the first and second overvoltage protective units 3100 and 3200 may be equal to each other. However, when the discharge sheets 301 of the first and second overvoltage protective units 3100 and 3200 have the same materials as each other, if the distance between the first and second discharge electrodes and the distance between the third and fourth discharge electrodes are different from each other, the breakdown voltages may be different. When the breakdown voltages of the first and second overvoltage protective units 3100 and 3200 are equal to each other, the overvoltages may be uniformly discharged through the first and second overvoltage protective units 3100 and 3200. However, when the breakdown voltages are not equal to each other, the overvoltage may be concentrated on one of the first and second overvoltage protective units 3100 and 3200, and accordingly, cause deterioration of the one thereof. Also, even when two or more overvoltage protective units 3100 and 3200 are provided, one of the discharge electrodes may float as illustrated in FIG. 9, and each of the discharge electrodes may be provided in two or more as illustrated in FIG. 10. The above-described contents are described with reference to FIGS. 6 and 7, detailed description will be omitted.

Also, when the capacitor unit 2000 having the shape in FIGS. 8 to 10 is provided between the first and second overvoltage protective units 3100 and 3200, the first and second coupling layers 5100 and 5200 in FIG. 5 may be provided between the capacitor unit 2000 and the first and second overvoltage protective units 3100 and 3200.

As described above, the complex device in accordance with an exemplary embodiment may include two or more functional layers having functions different from each other, which are laminated therein. The material of one functional layer is partially contained in the other functional layer adjacent thereto, and the material of the other functional layer is partially contained in the one functional layer. For example, the capacitor unit 2000 and the overvoltage protective unit 3000 are laminated, the material forming the overvoltage protective unit 3000 is partially contained in the capacitor unit 2000, and the material forming the capacitor unit 2000 is partially contained in the overvoltage protective unit 3000. Here, the material forming the capacitor unit 2000 may be an constituent of the dielectric sheet having a predetermined dielectric constant, and the material forming the overvoltage protective unit 3000 may be an constituent of the discharge sheet having the characteristics of the varistor. As a different kind of material is contained in the functional layer as described above, a difference between contraction rates after simultaneous sintering of the laminated complex device may decrease to prevent delamination and crack. Also, as the coupling layer 5000 having an constituent different from that of each of the capacitor unit 2000 and the overvoltage protective unit 3000 is provided between the capacitor unit 2000 and the overvoltage protective unit 3000, the coupling force therebetween may be further improved.

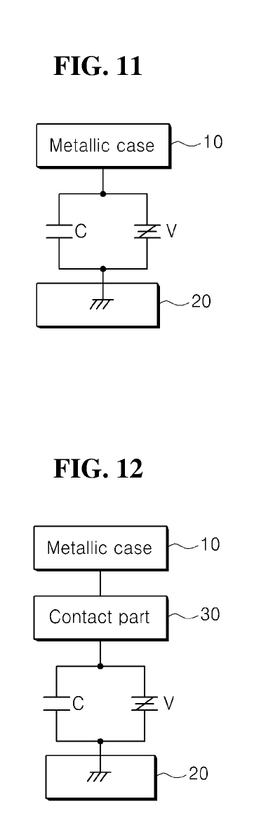

Meanwhile, the complex device in accordance with exemplary embodiments may be provided in electronic devices including a portable electronic device such as a smartphone. For example, as illustrated in FIG. 11, the complex device including the capacitor unit and the overvoltage protective unit may be provided between an internal circuit (e.g., PCB) of an electronic device and a conductive material that a user may touch, i.e., a metallic case 10. In FIG. 11, the capacitor unit is indicated by a numeral symbol of C, and the overvoltage protective unit is indicated by a numerical symbol of V. That is, in the complex device, one of the external electrodes 4000 may contact the metallic case 10, and the other thereof may contact the internal circuit 20. Here, a ground terminal may be disposed in the internal circuit 20. Accordingly, one of the external electrodes 4000 may contact the metallic case 10, and the other thereof may contact the ground terminal. Also, as illustrated in FIG. 12, a contact part 30 electrically contacting the metallic case 10 and having an elastic force may be provided between the metallic case 10 and the complex device. That is, the contact part 30 and the complex device in accordance with an exemplary embodiment may be provided between the metallic case 10 and the internal circuit of the electronic device. Here, in the complex device, one of the external electrodes 4000 may contact the contact part 30, and the other thereof may contact the ground terminal through the internal circuit 20. When an external force is applied to the electronic device from the outside, the contact part 30 may have the elastic force to relieve an impact and made of a material including a conductive material. The above-described contact part 30 may have a shape of a clip or a conductive gasket. Also, the contact part 30 may have at least one portion mounted on the internal circuit 20, e.g., PCB. As described above, the complex device may be provided between the metallic case 10 and the internal circuit 20 to block an electric shock voltage applied from the internal circuit 20. Also, the complex device may by-pass the overvoltage such as ESD voltage to the ground terminal and continuously block the electric shock voltage because the insulation is not broken down due to the overvoltage. That is, in the complex device in accordance with an exemplary embodiment, a current may not flow between the external electrodes 4000 at a rated voltage and a electric shock voltage, and a current may flow through the overvoltage protective unit 3000 at an overvoltage such as ESD, so that the overvoltage is by-passed to the ground terminal. Meanwhile, the complex device may have the breakdown voltage or the discharge inception voltage that is greater than the rated voltage and less than the overvoltage such as ESD. For example, the complex device may have the rated voltage of 100 V to 240 V, the electric shock voltage equal to or greater than an operation voltage, the overvoltage generated by static electricity, which is greater than the electric shock voltage, and the breakdown voltage or the discharge inception voltage of 350 V to 15 kV. Also, a communication signal may be transmitted between the internal circuit 20 and the outside by the capacitor unit 2000. That is, the communication signal from the outside, e.g., a RF signal, may be transmitted to the internal circuit 20 through the capacitor unit 2000, and the communication signal from the internal circuit 20 may be transmitted to the outside by the capacitor unit 2000. Accordingly, when the metallic case 10 is used as an antenna without a separate antenna, the capacitor unit 2000 may be used to exchange the communication signal from/to the outside. Eventually, the complex device in accordance with an exemplary embodiment may block the electric shock voltage applied from the ground terminal of the internal circuit, by-pass the overvoltage applied from the outside to the ground terminal, and transmit the communication signal between the outside and the electronic device.

Also, the complex device in accordance with an exemplary embodiment may be disposed between the metallic case 10 and the internal circuit 20 and used as the electric shock preventing component, maintain the insulation resistance state to prevent a leakage current from flowing when the electric shock of, e.g., 310 V is introduced from the internal circuit to the metallic case due to a defective charger as the capacitor unit 2000 is formed by laminating the plurality of insulation sheets, i.e., the dielectric sheets, having pressure withstand characteristics, and maintain a high insulation resistance state because the overvoltage protective unit by-passes the overvoltage when the overvoltage is introduced from the metallic case to the internal circuit. Accordingly, the complex device may have the insulation that is not broken down by the overvoltage, and accordingly, be provided in the electronic device including the metallic case to continuously prevent the electric shock voltage generated from the defective charger from being transmitted to the user through the metallic case of the electronic device.

### Experimental Example

Table. 1 shows a contraction rate on the basis of a temperature of the complex device in accordance with a comparative example and exemplary embodiments. A comparative example 1 has a composition of the varistor, and a comparative example 2 has a composition of the capacitor. Here, the varistor material has a composition in which 96 wt % of ZnO, 2 wt % of Pr₆O₁₁, and the rest of the varistor material or impurities on the basis of 100 wt %. The capacitor material has a composition in which 96 wt % of BaTiO₃, 15 wt % of NdTiO₃, and the rest of the capacitor material or impurities on the basis of 100 wt %. Also, in the exemplary embodiments 1 to 4, the capacitor material having the above composition is partially added to the varistor material, and the capacitor material is added at 2 wt % in the exemplary embodiment 1, 4 wt % in the exemplary embodiment 2, 7 wt % in the exemplary embodiment 3, and 10 wt % in the exemplary embodiment 4. That is, the capacitor material is added at 2 wt % in the in the exemplary embodiment 1, 4 wt % in the exemplary embodiment 2, 7 wt % in the exemplary embodiment 3, and 10 wt % in the exemplary embodiment 4 on the basis of 100 wt % of a mixed material of the varistor material and the capacitor material. Also, in the exemplary embodiments 5 and 6, the varistor material having the above composition is partially added to the capacitor material, and the varistor material is added at 3 wt % in the exemplary embodiment 5 and 5 wt % in exemplary embodiment 6. That is, the varistor material is added at 3 wt % in the exemplary embodiment 5 and 5 wt % in the exemplary embodiment 6 on the basis of 100 wt % of the mixed material of the capacitor material and the varistor material.

Using the material having the composition in accordance with the comparative examples and the exemplary embodiments, the sheet having a predetermined thickness is manufactured in plurality and laminated to form the varistor and the capacitor in accordance with the comparative examples and the varistor and the capacitor in accordance with the exemplary embodiments. Also, the contraction rate is measured at each of temperatures from 700° C. to 1170° C.

TABLE 1

| | Contraction | | | | | | | Total |
|---|---|---|---|---|---|---|---|---|
| | behavior | Contraction rate for each temperature (%) | | | | | | contraction |
| | temperature(° C.) | 700° C. | 800° C. | 900° C. | 1000° C. | 1100° C. | 1170° C. | rate (%) |
| Comparative | 756.9° C. | −0.91% | −0.90% | −2.51% | −6.91% | −12.31% | −15.94% | −15.93% |
| example 1 | | | | | | | | |
| Exemplary | 958.8° C. | −0.80% | −0.77% | −1.08% | −3.94% | −9.65% | −13.40% | −13.41% |
| embodiment 1 | | | | | | | | |
| Exemplary | 990.9° C. | −0.70% | −0.67% | −0.89% | −3.17% | −9.58% | −13.64% | −13.65% |
| embodiment 2 | | | | | | | | |
| Exemplary | 969.0° C. | −0.95% | −0.92% | −1.25% | −4.71% | −13.73% | −17.70% | −17.67% |
| embodiment 3 | | | | | | | | |
| Exemplary | 948.3° C. | −1.10% | −1.13% | −1.80% | −11.85% | −20.26% | −22.02% | −22.02% |
| embodiment 4 | | | | | | | | |
| Comparative | 914.5° C. | −0.65% | −1.18% | −4.52% | −10.02% | −16.78% | −20.63% | −20.67% |
| example 2 | | | | | | | | |
| Exemplary | 941.2° C. | −0.60% | −0.79% | −2.25% | −5.33% | −11.37% | −15.38% | −15.37% |
| embodiment 5 | | | | | | | | |
| Exemplary | 956.8° C. | −0.44% | −0.58% | −1.71% | −2.88% | −6.96% | −12.10% | −12.09% |
| embodiment 6 | | | | | | | | |

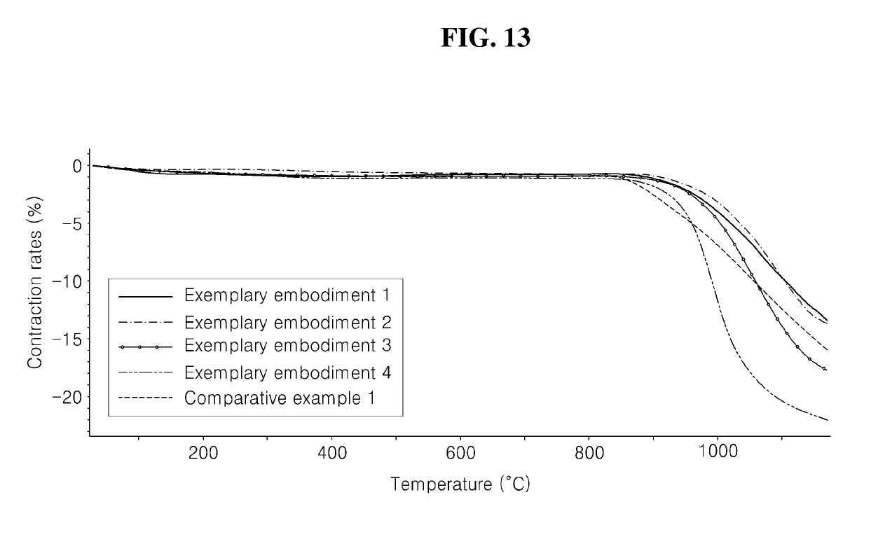

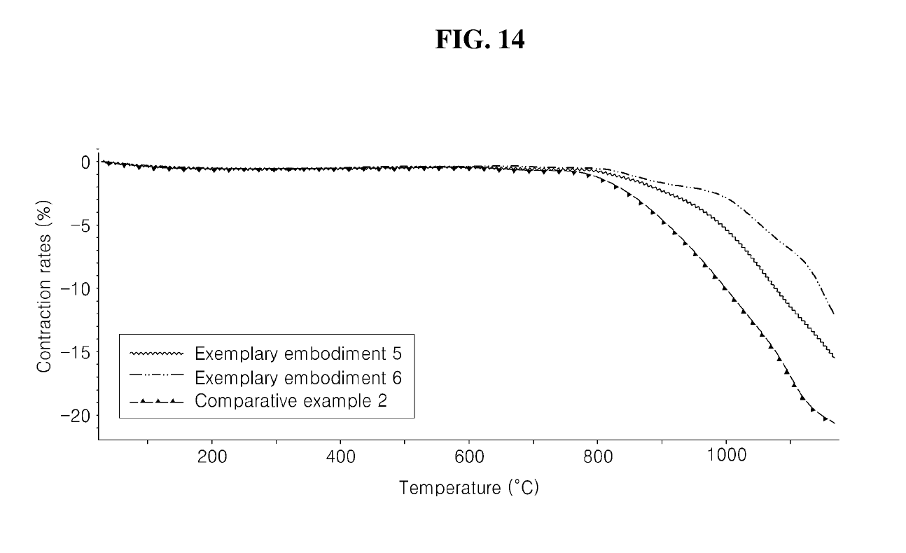

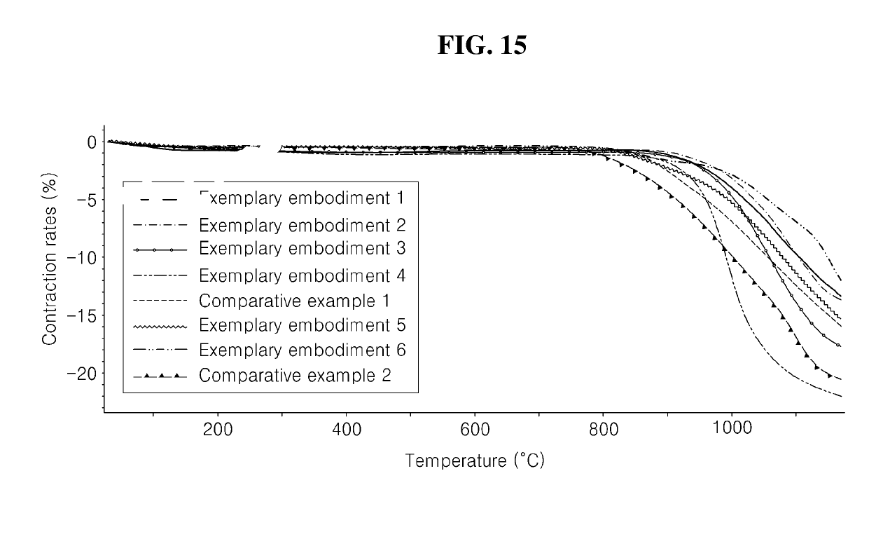

Results in accordance with the comparative example 1 and the exemplary embodiments 1 to 4 are illustrated in FIG. 13, and results in accordance with the comparative example 2 and the exemplary embodiments 5 and 6 are illustrated in FIG. 14. Also, results in accordance with the comparative examples 1 and 2 and the exemplary embodiments 1 to 6 are illustrated in FIG. 15. As described above, the contraction rate of the exemplary embodiments may be reduced in comparison with that of the comparative examples. In particular, the contraction rate of the exemplary embodiments 1 and 2 may be reduced in comparison with that of the comparative example 1, and the contraction rate of the exemplary embodiments 5 and 6 is reduced in comparison with that of the comparative example 2. However, the variation in the above-described contraction rate may use the composition of the varistor and the composition of the capacitor in accordance with a comparative example and an exemplary embodiment, the composition of the varistor and/or the composition of the capacitor are varied and the varistor material and the capacitor material are mixed to manufacture the complex device, thereby reducing the contraction rate and accordingly preventing the limitations such as delamination and crack.

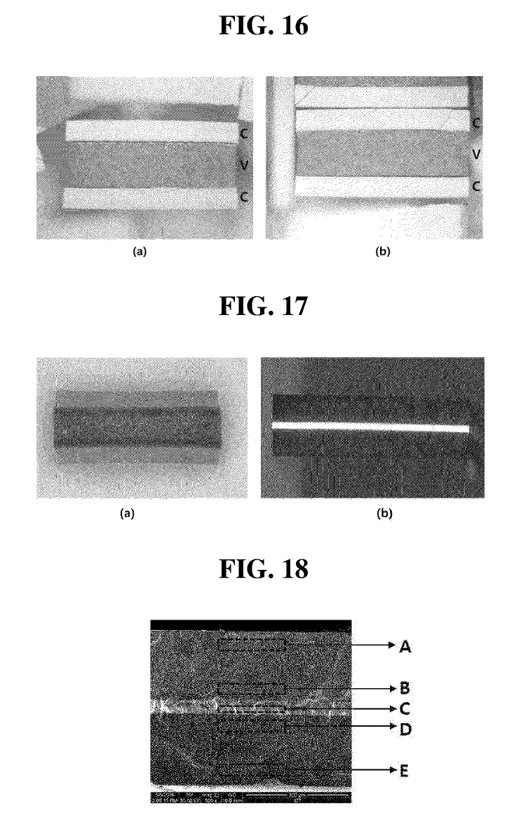

Also, FIG. 16 is a photograph of a side surface of the complex device that is manufacture by laminating the varistor having the composition in accordance with the comparative example 1 and the capacitor having the composition in accordance with the comparative example 2 and sintered at a temperature of 1000° C. As illustrated in (a) of FIG. 16, since the varistor and the capacitor are not adhered to each other, a layer separation phenomenon occurs, and, as illustrated in (b) of FIG. 16, a crack phenomenon occurs.

In comparison, FIG. 17 is a photograph showing a side surface of the complex device that is manufactured by using the varistor material having the composition in accordance with the exemplary embodiment 2 and the capacitor material having the composition in accordance with the exemplary embodiment 6 and sintered at a temperature of 1000° C. That is, the complex device, in which the varistor unit and the capacitor unit are laminated by using the varistor material having the composition in accordance with the exemplary embodiment 2 and the capacitor material having the composition in accordance with the exemplary embodiment 6, is manufactured. Here, (a) of FIG. 17 shows the complex device in which the capacitor unit is provided above and below the varistor unit with the varistor unit therebetween, and (b) of FIG. 17 shows the complex device in which the varistor is provided below and above the capacitor unit with the capacitor unit therebetween. As shown in FIG. 17, in accordance with an exemplary embodiment, the varistor unit and the capacitor unit are well adhered to each other to prevent the layer separation phenomenon in addition to crack.

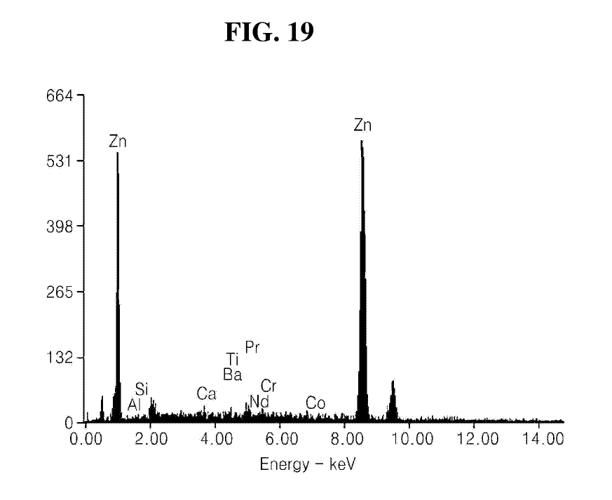

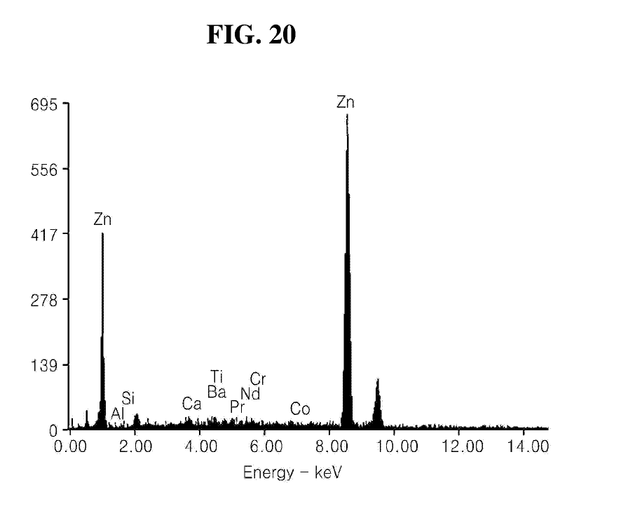

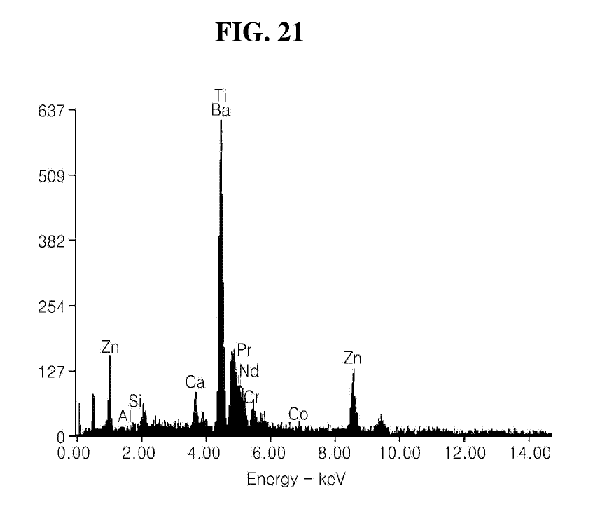

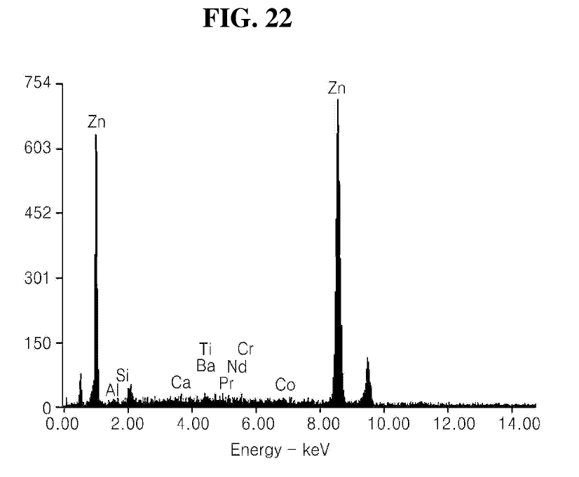

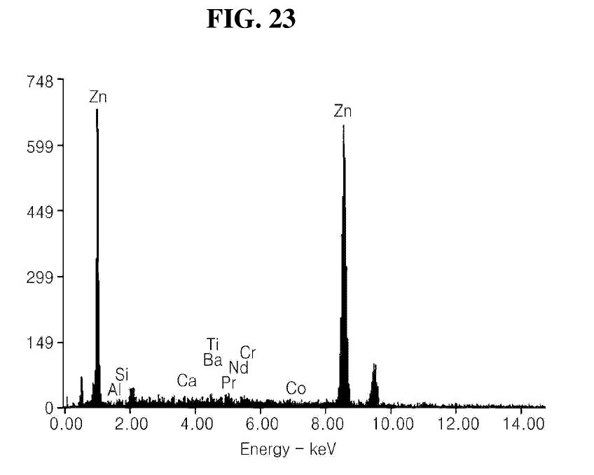

FIGS. 18 to 23 illustrate an EDX analysis for each portion of a complex device in accordance with an exemplary embodiment. That is, as illustrated in FIG. 18, the complex device, in which the capacitor unit is disposed on a central portion and the varistor unit is below and above the capacitor unit, includes an upper varistor unit A, a portion B between the upper varistor unit and a capacitor unit, the capacitor unit C, a portion D between the capacitor unit and a lower varistor unit, and the lower varistor unit E, and is analyzed through the EDX. Also, EDX analysis results for each area are shown in FIGS. 19 to 23. As illustrated in FIGS. 20 and 22, constituents of Ba, Nd, and Bi increase in the portion between the varistor unit and the capacitor unit. Thus, it is known that the coupling layer is disposed between the capacitor unit and the varistor unit.

The present invention may, however, be embodied in different forms and should not be construed as limited to the embodiments set forth herein. Therefore, it will be readily understood by those skilled in the art that various modifications and changes can be made thereto without departing from the spirit and scope of the present invention defined by the appended claims.

1. A complex device comprising:
a laminate; and
two or more functional layers disposed in the laminate and having functions different from each other,
wherein each of the two or more functional layers contains at least a portion of a material of another functional layer adjacent thereto.

2. The complex device of claim 1, wherein functional layers that are the same as each other are disposed on an upper portion and a lower portion in the laminate, and a different functional layer is disposed therebetween.

3. The complex device of claim 1, further comprising a coupling layer disposed between the two or more functional layers.

4. The complex device of claim 3, wherein the coupling layer has at least one of an constituent and a composition, which are different from those of the two or more functional layers.

5. The complex device of claim 3, wherein the coupling layer has at least one area having at least one of an constituent and a composition, which are different from those of another area.

6. The complex device of claim 2, wherein the functional layer comprises at least two of a resistor, a capacitor, an inductor, a noise filter, a varistor, and a suppressor.

7. The complex device of claim 6, wherein the functional layer comprises a capacitor unit and a varistor unit,
the capacitor unit comprises a plurality of dielectric sheets and two or more internal electrodes,
the varistor unit comprises a plurality of discharge sheets and two or more discharge electrodes,
each of the dielectric sheets contains a material of the discharge sheets, and each of the discharge sheets contains a material of the dielectric sheets.

8. The complex device of claim 7, wherein the dielectric sheet contains 0.2 wt % to 30 wt % of the material of the discharge sheet, and the discharge sheet contains 0.2 wt % to 30 wt % of the material of the dielectric sheet.

9. The complex device of claim 8, wherein a content of the material of the discharge sheet in the dielectric sheet gradually increases in a direction that is close to the varistor unit, and a content of the material of the dielectric sheet in the discharge sheet gradually increases in a direction that is close to the capacitor.

10. The complex device of claim 7, wherein the varistor unit is greater in thickness than the capacitor unit.

11. The complex device of claim 7, wherein a distance between the discharge sheets is greater than that between the internal electrodes.

12. The complex device of claim 7, wherein the internal electrode is greater in thickness than the discharge electrode.

13. The complex device of claim 7, wherein an overlapped surface area between the internal electrodes is greater than that between the discharge electrodes.

14. The complex device of claim 7, further comprising a coating layer of at least one of polymer and glass, which is formed on a surface of the laminate.

15. An electronic device comprising a conductor that a user may touch and an internal circuit with a complex device disposed therebetween,
the electronic device comprising a complex device comprising a laminate and two or more functional layers disposed in the laminate and having functions different from each other, wherein at least a portion of each of the two or more functional layers contains at least a portion of a material of another functional layer adjacent thereto.

16. The electronic device of claim 15, further comprising a coupling layer disposed between the two or more functional layers.

17. The electronic device of claim 16, wherein the coupling layer has at least one of an constituent and a composition, which are different from those of the two or more functional layers.

18. The electronic device of claim 15, wherein the functional layer comprises a capacitor unit and a varistor unit,
the capacitor unit comprises a plurality of dielectric sheets and two or more internal electrodes,
the varistor unit comprises a plurality of discharge sheets and two or more discharge electrodes,
each of the dielectric sheets contains a material of the discharge sheets, and each of the discharge sheets contains a material of the dielectric sheets.

19. The electronic device of claim 18, wherein the dielectric sheet contains 0.2 wt % to 30 wt % of the material of the discharge sheet, and the discharge sheet contains 0.2 wt % to 30 wt % of the dielectric sheet.

20. The electronic device of claim 15, wherein the complex device allows a transient voltage applied from the outside through the conductor to by-pass through the internal circuit, blocks an electric shock voltage leaked through the internal circuit, and allows a communication signal to pass through.
